(19) United States
(12) Patent Application Publication
(10) Pub. No.: US 2024/0236602 A1
(43) Pub. Date: Jul. 11, 2024

(54) DYNAMIC TORSO REFLECTION FILTERING FOR SPATIALIZED AUDIO BASED ON BIOLOGICALLY CONSTRAINED IMU DRIFT COMPENSATION

(71) Applicant: Meta Platforms Technologies, LLC, Menlo Park, CA (US)

(72) Inventors: Philip ROBINSON, Seattle, WA (US); William Owen BRIMIJOIN, II, Kirkland, WA (US); Antje IHLEFELD, Redmond, WA (US)

(21) Appl. No.: 18/612,758

(22) Filed: Mar. 21, 2024

Related U.S. Application Data
(60) Provisional application No. 63/456,830, filed on Apr. 4, 2023.

(51) Int. Cl. H04S 7/00

(52) U.S. Cl. CPC H04S 7/303; H04S 2420/01

(57) ABSTRACT

Techniques are described for generating spatialized audio content based on head orientation information and torso orientation information obtained from a drift compensation system. The drift compensation system compensates for drift in measurements performed by an inertial measurement unit (IMU), based on biological constraints pertaining to a user. The head orientation information is applied to a first set of filters to generate intermediate audio content. In turn, the torso orientation information and the intermediate audio content are applied to a second set of filters to generate the spatialized audio content. The first set of filters includes one or more audio filters that receive an input audio signal corresponding to a left channel. The second set of filters includes one or more audio filters that receive an input audio signal corresponding to a right channel. The spatialized audio content includes separate output signals for the left channel and the right channel.

### CROSS-REFERENCE TO RELATED APPLICATIONS

This application claims the benefit of U.S. Provisional Application No. 63/456,830, filed Apr. 4, 2023, which is incorporated by reference herein in its entirety for all purposes.

### FIELD OF THE INVENTION

The present disclosure generally relates to spatializing audio content, and specifically relates to dynamic torso reflection filtering for interactive binaural spatial audio based on biologically constrained IMU drift compensation.

### BACKGROUND

Conventional audio systems use frequency-domain multiplication to process head-related transfer functions (HRTFs) for the generation of spatialized audio content. However, conventional HRTFs typically fail to account for changes in orientation between the head and the torso. Moreover, time-domain convolution of HRTFs require significant computational resources, power, and memory. This makes these devices non-ideal for use in resource-constrained devices, such as a headset, with limited compute resources, limited memory, limited power, and small form factors.

### BRIEF DESCRIPTION OF THE DRAWINGS

FIG. 1 shows an example of audio system components configured to determine filters for generating spatialized audio using head orientation and torso orientation, in accordance with one or more embodiments.

The figures depict embodiments of the present disclosure for purposes of illustration only. One skilled in the art will readily recognize from the following description that alternative embodiments of the structures and methods illustrated may be employed without departing from the principles described herein.

### DETAILED DESCRIPTION

Described herein is an audio system and corresponding methods for controlling the audio system to generate interactive binaural spatial audio for output to a user of a device that includes a drift compensation system for an inertial measurement unit (IMU) onboard the device. Specifically, aspects of the disclosure relate to applying dynamic torso reflection filtering to filter binaural audio signals, using audio filters that are configured according to head orientation and torso orientation. Information about the user's head and torso are derived from measurements performed by the IMU of the device and, optionally, from IMU or other sensor measurements of one or more secondary devices associated with the user. The drift compensation system of the device operates to compensate for drift in IMU measurements in a biologically constrained manner, for example, based on assumptions regarding head movement, torso movement, and head position relative to torso position. The audio system may be integrated into the device and/or communicatively coupled to the device. In some embodiments, the device may be a wearable device. The head and torso information may be provided to a time and level difference renderer (TLDR) of the audio system for generating spatialized audio content.

In some embodiments, the drift compensation system comprises the IMU integrated into a headset worn by a user (e.g., a head-mounted display device in an artificial reality system). The drift compensation system tracks the position of the headset using measurements from the IMU. The drift compensation system may track the position of the headset in terms of yaw, roll, and pitch measurements. The measurements may be in terms of an angle measurement (e.g., in degrees or in radians) and/or in terms of a rate (e.g., in degrees per second, in radians per second, etc.). When the user is wearing the headset, the yaw measurement relates to the amount the user turns their head to the left or to the right (i.e., a rotation about the yaw axis). The roll measurement relates to the amount the user tilts their head to the left and to the right (i.e., a rotation about the roll axis). The pitch measurement relates to the amount the user tilts their head up and down (i.e., a rotation about the pitch axis). The drift compensation system tracks the current yaw, roll, and pitch measurement relative to the last yaw, roll, and pitch measurement (i.e., changes in yaw, roll, and pitch measurements relative to the last yaw, roll, and pitch measurements). The IMU suffers from drift (i.e., an increasing difference in the actual position of the headset and the measured position of the headset).

The head of the user is biologically constrained in its positioning relative to the torso of the user. A biological constraint of the user is a limitation or restriction that is based in part on the user's biology (e.g., how the head moves via the neck relative to the torso). For instance, the head of the user may only turn from the far left to the far right a maximum of 180 degrees (i.e., maximum yaw measurement). The head of the user may only tilt a maximum of 90 degrees (i.e., maximum roll measurement or maximum pitch measurement). Over time, the head of the user generally remains at some nominal position (e.g., squared to the shoulders looking straight ahead) relative to a torso of the user. A nominal position of the user may be established based on the positioning of the head of the user as the head of the user remains still over a predetermined time period. The nominal position may differ from user to user. For example, a nominal position of one user may have the head facing towards the front (i.e., squared with shoulders) with little to no tilt, and a nominal position for a different user may also have the head at a different position. A nominal position may be associated with a yaw measurement, a roll measurement, and a pitch measurement of zero degrees. When the neck of the user turns the head of the user to the left or to the right (i.e. introduces some yaw), the neck also tilts the head of the user (i.e., introduces some roll).

Utilizing the biological constraints and a set of position parameters, the drift compensation system may determine a drift correction component to compensate for drift present in the IMU over time. The set of position parameters may include, e.g., a yaw measurement, a roll measurement, a pitch measurement for the headset. In some embodiments, the set of position parameters may be measured relative to the torso. The set of position parameters may be determined by the IMU of the headset. In some embodiments, other secondary devices (e.g., other headsets, other mobile devices, etc.) may be used to determine some or all of the position parameters. The position parameters may include pose information about the user. Pose information describes the positioning of the head of the user. The pose information may include additional position measurements (e.g., a second yaw, roll, and pitch measurement), an indication that the head positioning of the user (e.g., relative to the torso) has undergone a change, a notification of the type of change (e.g., a change in yaw, a change in roll, a change in pitch, or some combination thereof) the head positioning has undergone, or some combination thereof.

Pose information may optionally be obtained from different sources (e.g., the drift compensation system may provide head orientation while a secondary device provides torso orientation). In one embodiment, a secondary device may determine pose information based on changes in sound detected by an audio system of the secondary device. In another embodiment, the headset may determine pose information based on changes in sound detected by an audio system of the headset. In one embodiment, the secondary device may determine pose information based on an analysis of one or more images of a head (including the headset) and a torso of the user captured by the secondary device. In another embodiment, the headset may determine pose information based on analysis of one or more images of a head (including the headset) and a torso of the user provided by the secondary device, in accordance with one or more privacy settings of the user. The secondary device may determine pose information by utilizing an IMU integrated into the secondary device. The secondary device may provide, in accordance with privacy settings of the user, the pose information to the IMU to be included in the set of position parameters.

The set of position parameters and the biological constraints of the positioning of the head of the user are utilized by the drift compensation system to determine the drift correction component, which describes a rate of correction. The drift correction component is applied to subsequent measurements (e.g., yaw measurements) of the IMU at the rate of correction. The drift correction component forces an estimated nominal position vector (i.e., a vector based on the nominal positioning of the head of the user) to a pointing vector (i.e., a vector based on the current measured positioning of the head of the user) during the subsequent measurements of the IMU. The drift correction component may include a yaw drift rate measured in degrees over time. The yaw drift rate may be inversely proportional to the amount of roll measured. In some embodiments, the drift correction component may further include a roll drift rate measured in degrees over time. In some embodiments, the drift correction component effectively adjusts for any drift error present in the subsequent yaw measurements, thereby compensating for drift present in the IMU over time.

The audio system may include an audio controller that uses a head orientation and a torso orientation received from the drift compensation system to determine filters for presenting spatial audio. The audio controller is configured to use a TLDR and the received head orientation and torso orientation to determine the filters. The TLDR may include a cascaded series of filters and delay elements for introducing delay based on the head orientation, and a separate set of cascaded filters and delay elements for the torso orientation. The filters of the TLDR may include different types of infinite impulse response (IIR) filters. The audio controller applies the TLDR to an audio signal received at a single channel to generate spatialized audio content corresponding to multiple channels (e.g., left channel and right channel audio signals) for a given head orientation and torso orientation.

The TLDR may have a set of configured monaural static filters (with 0, 1, 2, . . . number of monaural static filters in the set) and a set of configured monaural dynamic filters (with 0, 1, 2, . . . number of monaural dynamic filters in the set) connected to the set of monaural static filters. The monaural static and dynamic filters are connected (i.e., receive input audio signal and generate an output audio signal) through the single channel. In some embodiments, there may also be static binaural filters that perform individualized left/right speaker equalization. The TLDR also has a set of configured binaural dynamic filters (with 1, 2, . . . , number of pairs of binaural dynamic filters in the set) that are connected (i.e., receive an input audio signal and generate an output audio signal) through each channel of multiple audio channels (such as a connected left channel and a connected right channel). In addition, the TLDR may have a configured delay between the multiple audio channels. The audio controller is configured to apply the head orientation information to a first set of binaural dynamic filters to generate intermediate audio content. Intermediate audio content refers to the audio signals for the left channel, right channel, or both, that have been processed for head orientation, but have not yet been processed using torso orientation.

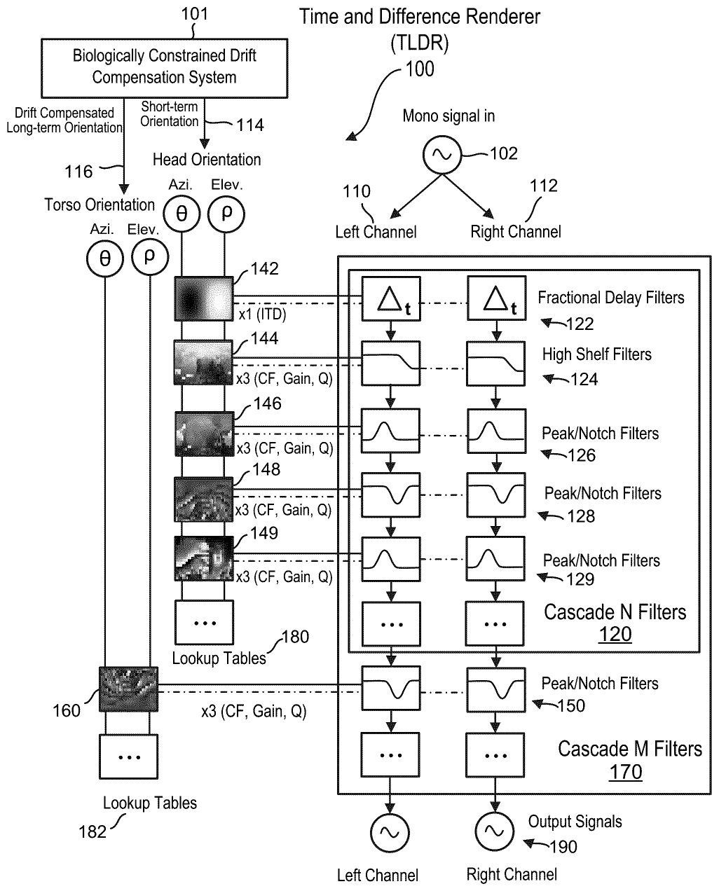

FIG. 1 shows an example of a TLDR 100 configured to determine filters for spatialized audio using both head orientation and torso orientation, in accordance with one or more embodiments. As shown in FIG. 1, a mono channel input signal 102 is split into a left channel 110 and right channel 112. In the example of FIG. 1, the TLDR 100 receives information indicating head orientation 114 and torso orientation 116 from a biologically constrained drift compensation system 101. The drift compensation system 101 operates to compensate drift in the measurements of an IMU (not shown), which may be integrated into a wearable device such as a headset (e.g., a head-mounted display device configured to present artificial reality content). However, as discussed above, head and torso information can also be supplied by additional devices. For example, the torso information 116 could be supplied by a separate IMU-equipped device carried or worn on another part of the user's body. The TLDR 100 is part of an audio system integrated with and/or coupled to the device having the IMU. Although not shown, it will be understood that the audio system may include other components, such as audio output devices (e.g., a left speaker and a right speaker) used to present spatialized audio content to a user of the device.

The drift compensation system 101 may be configured to distinguish between head and torso movements. In particular, the drift compensation system 101 may determine the head orientation 114 based on IMU measurements indicating rapid movement of the device, which is associated with head rotation (e.g., yaw angle when the yaw rate exceeds a certain threshold). Further, the drift compensation system 101 may determine the torso orientation 116 based on IMU measurements indicating slower movement of the device, which is associated with torso rotation. Because the measurements used to determine torso orientation are performed over a longer period of time, the torso orientation 116 may be a drift-compensated, long-term estimate. By contrast, the head orientation 114 may be a non-compensated, short-term orientation estimate. As shown in FIG. 1, the orientation information may describe head and torso orientation within a horizontal coordinate system, using azimuth and elevation values (θ, ρ). Other types of values may be used to describe orientation depending on the coordinate system employed by the drift compensation system 101.

The TLDR 100 uses the head orientation 114 as inputs to a first set of filters 120, through a set of delay elements, to form intermediate audio content that is combined with the torso orientation 116 using a second set of filters 150. The filters in the first set of filters 120 are cascaded together and may include any number of fractional delay filters, high shelf filters, peak/notch filters, and/or other audio filters. Each filter in the first set of filters 120 receives a corresponding input audio signal (e.g., from the preceding filter) together with the output of a corresponding delay element. The output of the corresponding delay element configures the filter to act on the corresponding input audio signal according to the head orientation 114. In the example of FIG. 1, the first set of filters 120 includes N pairs of filters. Each filter pair can be considered a binaural filter having a filter for the left channel 110 and a corresponding filter for the right channel 112.

The delay elements for the head orientation 114 include at least one pair of delay elements (one for azimuth, the other for elevation) for each filter in the first set of filters 120. For example, a first pair of delay elements 142 forms input to a pair of fractional delay filters 122 to influence interaural time difference (ITD). However, there can be multiple such pairs of delay elements that form inputs to a filter depending on how the filter operates. For example, three pairs of delay elements 144 form inputs to a pair of high shelf filters 124 to influence cutoff frequency (CF), gain, and quality (Q) factor. Similarly, delay elements 146, delay elements 148, and delay elements 149 each include three pairs of delay elements to influence cutoff frequency, gain, and Q factor for peak/notch filters 126, peak/notch filters 128, and peak/notch filters 129, respectively.

The torso orientation 116 may be processed in a similar manner as the head orientation 114. Specifically, the TLDR 100 receives the torso orientation 116 as input to a second set of filters 150 through a set of delay elements 160. In this example, the second set of filters 150 includes a pair of peak/notch filters. However, like the first set of filters 120, the second set of filters 150 may include any number of filter pairs. The number of delay elements 160 that delay the torso orientation 116 will vary accordingly. Together with the first set of filters 120, the second set of filters 150 forms an overall set of filters 170 (e.g., M pairs of filters in total, where M minus N equals the number of filters in the second set of filters 150) that are cascaded together to form output signals 190. The output signals 190 include a first output signal for the left channel 110 and a second output signal for the right channel 112, as spatialized audio content for presentation to the user. For example, the audio controller may use the output signals 190 to instruct a speaker array of the audio system to present the spatialized audio content to the user.

The delay elements and filters of the TLDR 100 may be configured to generate the spatialized audio content according to a head-related transfer function (HRTF) and accounting for the acoustic effects of head and torso orientation. An HRTF characterizes how a person's ear receives a sound from a point in space. When the person turns their head and shoulders together, the change in acoustic response at each ear is different than the change in acoustic response when the person turns their head on their shoulders, primarily due to shoulder and torso reflection.

Accordingly, the TLDR 100 may use the delay elements and filters to better reproduce the acoustic effects of head and torso orientation on an HRTF used to generate audio content for the user's left ear and, similarly, to better reproduce the acoustic effects of head and torso orientation on an HRTF used to generate audio content for the user's right ear. In some embodiments, there may be little or no change in an HRTF when the user's head rotates with their torso since it may be assumed that the torso direction corresponds to a long-term forward direction, including drift correction towards the long-term forward direction. In contrast, HRTF may change dynamically and to a much larger extent when the user's head rotates relative to their torso.

Note that FIG. 1 illustrates a specific set of filters and delays. In other embodiments, the number and/or type of filters may vary for generating intermediate audio content and/or for generating spatialized audio content. Additionally, it should be noted that the number of filters and delays used to generate the output signals 190 is not necessarily fixed. For example, which filters in the first set of filters 120 to use and their filter parameters (e.g., CF, gain, or Q factor values) may along with the amount of delay introduced to the head orientation 114, be determined based on a first set of lookup tables 180, using the head orientation 114 as an input to the first set of lookup tables 180. Similarly, which filters in the second set of filters 150 to use and their filter parameters may along with the amount of delay introduced to the torso orientation 116, be determined based on a second set of lookup tables 182, using the torso orientation 116 as an input to the second set of lookup tables 182. Depending on head or torso orientation, one or more filters may be bypassed or configured according to a different set of filter parameters, and one or more delay elements may be configured with a different amount of delay.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality and/or are otherwise used in an artificial reality. The artificial reality system that provides the artificial reality content may be implemented on various platforms, including a wearable device (e.g., headset) connected to a host computer system, a standalone wearable device (e.g., headset), a mobile device or computing system, or any other hardware platform capable of providing artificial reality content to one or more viewers.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized or special-purpose hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium,” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer program product may include code and/or machine-executable instructions that may represent a procedure, a function, a subprogram, a program, a routine, an application (App), a subroutine, a module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms, “and” and “or” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or a combination of A, B, and/or C, such as AB, AC, BC, AA, ABC, AAB, ACC, AABBCCC, or the like.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components, or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A method comprising:
receiving head orientation information and torso orientation information from a drift compensation system for an inertial measurement unit (IMU), wherein the drift compensation system is configured to compensate for drift in measurements performed by the IMU, based on biological constraints pertaining to a user;
applying the head orientation information to a first set of filters to generate intermediate audio content;
applying the torso orientation information and the intermediate audio content to a second set of filters to generate spatialized audio content, wherein:
the first set of filters comprises one or more audio filters that receive an input audio signal corresponding to a left channel,
the second set of filters comprises one or more audio filters that receive an input audio signal corresponding to a right channel, and
the spatialized audio content comprises a first output signal for the left channel and a second output signal for the right channel; and
presenting the spatialized audio content to the user.

2. The method of claim 1, wherein the spatialized audio content is generated using one or more head-related transfer functions.

3. The method of claim 1, wherein the head orientation information and the torso orientation information each comprise an azimuth value in combination with an elevation value.

4. The method of claim 1, wherein the torso orientation information corresponds to a drift compensated, long-term estimate of the user's torso orientation as determined from the measurements performed by the IMU.

5. The method of claim 1, wherein the head orientation information corresponds to a non-compensated, short-term estimate of the user's head orientation as determined from the measurements performed by the IMU.

6. The method of claim 1, further comprising:
configuring the first set of filters based on a result of applying the head orientation information as an input to a lookup operation.

7. The method of claim 1, further comprising:
configuring the second set of filters based on a result of applying the torso orientation information as an input to a lookup operation.

8. The method of claim 1, wherein:
the first set of filters comprises a first plurality of audio filters that are cascaded with each other and the second set of filters.

9. The method of claim 8, wherein:
the second set of filters comprises a second plurality of audio filters that are cascaded with each other and the first set of filters.

10. An audio system comprising:
a speaker array including a left speaker and a right speaker; and
an audio controller configured to:
receive head orientation information and torso orientation information from a drift compensation system for an inertial measurement unit (IMU), wherein the drift compensation system is configured to compensate for drift in measurements performed by the IMU, based on biological constraints pertaining to a user;
apply the head orientation information to a first set of filters to generate intermediate audio content;
apply the torso orientation information and the intermediate audio content to a second set of filters to generate spatialized audio content, wherein:
the first set of filters comprises one or more audio filters that receive an input audio signal corresponding to a left channel,
the second set of filters comprises one or more audio filters that receive an input audio signal corresponding to a right channel, and
the spatialized audio content comprises a first output signal for the left channel and a second output signal for the right channel; and
present the spatialized audio content to the user through the speaker array.
